(19) United States
(12) Patent Application Publication
(10) Pub. No.: US 2014/0379612 A1
(43) Pub. Date: Dec. 25, 2014

(54) Leveraging to Minimize the Expected Inverse Assets

(71) Applicant: Rory Mulvaney, Fargo, ND (US)

(72) Inventor: Rory Mulvaney, Fargo, ND (US)

(21) Appl. No.: 14/480,587

(22) Filed: Sep. 8, 2014

Related U.S. Application Data
(63) Continuation-in-part of application No. 14/146,810, filed on Jan. 3, 2014, now abandoned.
Application No. 14/146,810 is a continuation-in-part of application No. 14/021,195, filed on Sep. 9, 2013, now abandoned.
Application No. 14/021,195 is a continuation-in-part of application No. 13/052,065, filed on Mar. 19, 2011, now abandoned.
(60) Provisional application No. 61/320,483, filed on Apr. 2, 2010.

(51) Int. Cl. G06Q 40/06

(52) U.S. Cl. CPC G06Q 40/06
USPC 705/36 R

(57) ABSTRACT

The question of how much should be placed at risk on a given investment, relative to the total assets available for investment, is basically that of determining the optimal leverage. The approach taken by the method described in this specification is to optimize the expected future inverse assets, conditioned on the assets having some estimated linear return distribution. The expected inverse assets is shown to outperform the Kelly Criterion, an existing well known method for calculating optimal leverage, using a simple cross evaluation method, whereby the optimum leverage according to one method is measured using the other method's utility function. The expected inverse assets measure outperforms the Kelly Criterion in the two analytic scenarios considered, a Gaussian distribution of log-returns and a Bernoulli distribution of linear returns. Example usage of the expected inverse asset utility or objective function is provided by the specification of a system of processing histograms that represent the forecast return distributions of investments. It is also shown how this system can be applied specifically to leveraging with market equities, leveraging with debt, leveraging in insurance, and leveraging in a retirement portfolio.

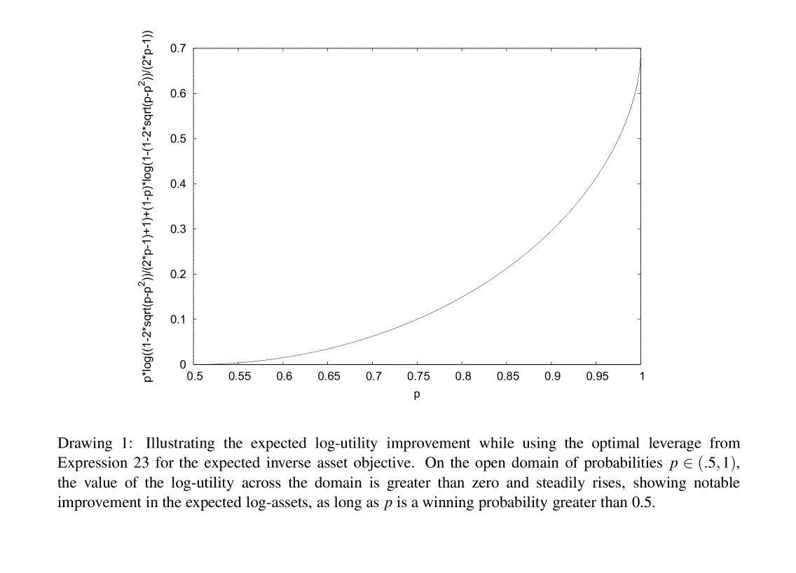

### TECHNICAL FIELD

A very important high-level strategy in finance relates to the amount of money to place at risk, or equivalently, how much leverage to apply. This is a field relating to Finance and Actuary Science. Because financial time series are often analyzed using probability distribution, this is also a field related to Probability Theory. Finally, numerical computing techniques from Computer Science are also involved. The invention claims seem to fit most appropriately into the U.S. patent classification 705/36R, on portfolio selection, planning, or analysis.

### BACKGROUND

Leverage can be thought of as a multiplier of the assets eligible for investment, controlling the percentage of one's money that is invested or being bet on something. It is of course possible to actually invest multiples of one's assets through borrowing money “on margin” to invest it. The leverage is a fraction, where the numerator is the portion of assets actually placed at risk as investment, and the denominator is the total portion of the gross assets that are being considered eligible for investment, possibly including debt assets but excluding margin account debt. The reason margin debt is not considered in the denominator is that it is itself dependent on the numerator and denominator as defined above, and so it would create a sort of double-dependence complexity if it were considered part of the denominator.

A leverage-dependent criterion (from which the optimal leverage is derived) can be derived from the projected distribution of investment returns using a utility function. Thus there are two important variables in the process: (a) perhaps most importantly, the choice of the utility function, and (b) the choice of the model for the future distribution of returns.

Perhaps the most basic method to predict the future distribution of the logarithm of a stock price is to model it using Brownian motion with drift, also known as a Wiener process with drift, having a time-dependent Gaussian distribution “with drift” that may be expressed as

$${p}_{Gauss} ( x ; ln ( {A}_{0} ) + uT , {σ}^{2} T ) , \\ where \\ {p}_{Gauss} ( x ; m , {s}^{2} ) = \frac{1}{\sqrt{2 π} s} {e}^{\frac{- {( x - m )}^{2}}{2 {s}^{2}}} . \qquad ( 1 )$$

Note that p(x; m, s²) is simply a Gaussian distribution in x with mean m and variance s². In this formula, u is the growth rate per unit time T in the log-value log(A) (where A₀ represents the starting value of the stock or assets), and σ² represents the variance of the growth in log-assets per time period. In this specification the term “volatility” refers to σ (the standard deviation of the growth in log-assets per time period), though sometimes other literature defines volatility differently.

Another simple model that may be considered is the binomial distribution for the purpose of modeling a series of win-or-lose bets. Here, the model operates in discrete time steps, whereas the lognormal stock price model above operates in continuous time.

Utility functions are a matter of importance because money is not valued on a linear scale, as illustrated by the St. Petersburg paradox [1, 2]. Bernoulli's 1738 proposed solution to this paradox was that money is probably typically measured on a logarithmic scale.

Literature from several sources on optimizing leverage point to something called the Kelly Criterion [3, 4, 5, 6]. The Kelly Criterion [3] uses a logarithmic utility function in discrete time to basically show the optimal fraction of money to bet, given the true probabilities. In the simplest case of a bet on an event with two possible outcomes, the Kelly Criterion says to bet the fraction 2(p−0.5), where p is the probability of winning with the more probable guess.

According to Chan [4], the Kelly Criterion, which strictly technically speaking, only applies to discrete probability distributions encountered in making discrete-time bets, can also be applied to continuous-time financial time series following a derivation from [5], which derives a leverage-dependent criterion in terms of μ and σ′ using a utility function that measures the expected logarithm of the assets. The quantity μ is the expected value of the simple uncompounded percent gain for a given time period, and σ′ is the standard deviation of the distribution of μ. This derivation by Thorp [5] is summarized by Chan [4] to give the simple formula for the optimal leverage in Expression 2.

$$l = \frac{μ}{{σ}^{′ 2}} \qquad ( 2 )$$

Chan [4] points out that the Kelly Criterion can be used to further optimize the leverage of an asset that was chosen for its optimal Sharpe ratio, because the Sharpe ratio is basically unaffected by leverage.

According to Chan [4], many stock traders set their leverage according to the “Half Kelly” Criterion, which arbitrarily uses half of the Kelly Criterion leverage from Expression 2.

A patent by Scott, et al. [8] presents the utility function in Expression 3 in terms of the expected wealth E(W), the estimated variance of the wealth Var(W), and the subjective risk tolerance variable τ.

$$U = E ( W ) - \frac{Var ( W )}{τ} \qquad ( 3 )$$

In a paper by Peters [7] the Kelly Criterion for continuous time is again derived from a logarithmic utility function, except via a different method utilizing Itô's Lemma. Basically it is shown that if the linear leveraged returns lμ are Gaussian distributed with standard deviation lσ′, so are the log-returns u. The expected rate of change of the mean of the distribution of the logarithm of assets is

$$l μ - \frac{{l}^{2} {σ}^{2}}{2} ,$$

while the variance per time of that distribution is l²σ², where the standard deviation, σ′ of the linear returns μ, is actually found by Itô's Lemma to be equivalent to the standard deviation, σ of the log-returns u. Thus after application of calculus-based symbolic optimization with respect to l, it is shown that to maximize the expected rate of change of the mean of the log-assets, the leverage is optimized using the same continuous-time Kelly Criterion formula as above in Expression 2, with σ′=σ.

### SUMMARY

3.1 Technical Problem : There Exist A Pair of Simple Objective Functions with Valid Optimal Leverage Criteria

As mentioned in the background section, there are two important variables in the process of deriving a leveraging criterion, one of which is the choice of the model for the future distribution of returns. Although we already know the basic probability model for Brownian motion with drift from Expression 1, it does not contain any leverage dependence. To maintain constant leverage (if the leverage is anything other than 1), transactions need to be continually made while the stock price changes. If at first one accidentally ignores Itô's Lemma, and observes that for very small time T,

log(1+lμ)≈lμ, (4)

so that the mean log growth rate u and its standard deviation σ are seemingly proportional to l for the very small price changes and time increments while the leverage is kept constant. This proportionality of l with the log-return u and standard deviation σ thereof would seemingly lead to the presumption that the distribution of log returns is a Gaussian distribution of the form p_{Gauss} (x; 1 n(A₀)+lTu, l²σ²T)
3.1.1 Problem: Ignoring Itô's Lemma, Linear Utility Implies Infinite Leverage

The expected linear utility of a leveraged model of Brownian motion with drift is given by Expression 5, where p_{Gauss} (x; m, σ²) is the Gaussian probability density function in x with mean m and variance σ² from Expression 1. Expression 5 computes the expected value of e^{x}, where x represents the log-assets, having a Gaussian distribution specified by Brownian motion with drift, at time T and initial assets A₀. Thus the expected value of e^{x} is the expected value of the assets.

∫_{-∞}^{∞}e^{x}p_{Gauss}(x; log(A₀)+lu(l)T, σ(l)²l²T)dx (5)

Evaluation of the integral in Expression 5 yields Expression 6.

$$exp ( \frac{T ( 2 lu ( l ) + {l}^{2} {σ ( l )}^{2} ) + 2 log ( {A}_{0} )}{2} ) \qquad ( 6 )$$

Therefore, maximization, with respect to leverage, of expected assets at time T, implies infinite leverage. Obviously, infinite leverage would result in bankruptcy on the slightest downturn of the stock price, but apparently the rare case of avoiding bankruptcy has such large rewards that it more than compensates for the low value of the bankrupt cases. Apparently, while accidentally ignoring any special effects from Itô's Lemma, linear utility sacrifices too much in safety for the hope of a very lucky win.
3.1.2 Problem: Ignoring Itô's Lemma, Logarithmic Utility Implies Infinite Leverage

Evaluation of the logarithmic utility is achieved by replacing e^{x} with x in the integral in Expression 5, to compute the expected log-assets at time T (because the Gaussian distribution is expressed in terms of the logarithm of the assets). The result is given by Expression 7, which again implies infinite leverage upon maximization with respect to leverage.

Tlu(l)+log(A₀) (7)

To conclude, while accidentally ignoring Itô's Lemma, it appears that the Kelly Criterion still has some claim to optimality for discrete-time bets, but not for (approximately) continuous-time risk, as that seen in the stock market.

3.1.3 Ignorance of Itô's Lemma, and Solution to the Infinite Leverage Problem¹

Upon the above accidental presentation of the infinite leverage problem with both linear and logarithmic utility, the hypothesis may readily be made that perhaps it works to instead minimize the multiplicative inverse of the assets [9, sec. 9]. More generally, one might propose a utility function with the goal of minimizing the expected value of y^{-b}, where y represents the random variable for the assets, and b is a positive real number. The expected value of this generalized utility function may be measured conditionally on a distribution given by the drifting Brownian motion model of the logarithm of assets, by replacing e^{x} in Expression 5 with e^{-bx}, because e^{-bx}=exp(−blog(y))=y^{-b}. Evaluation of that integral leads to Expression 8. This solution was originally presented in [9].

$$exp ( - \frac{T ( 2 blu ( l ) - {b}^{2} {l}^{2} {σ ( l )}^{2} ) + 2 b log ( {A}_{0} )}{2} ) \qquad ( 8 )$$

Minimization of Expression 8 leads to maximization, at any given T, of the simpler criterion

log(A₀)(lu(l)−½bl²σ(l)²)T. (9)

Dropping the asset term (because it is not dependent on leverage) and dividing by T, it becomes the maximization of

$$lu ( l ) - \frac{{bl}^{2} {σ ( l )}^{2}}{2} . \qquad ( 10 )$$

This is very similar to the criterion offered by Scott, et al. [8], listed above in Expression 3, except for the important difference that Expression 10 uses its mean and variance variables computed using the logarithm of asset levels, rather than the linear asset levels used by Scott, et al. (in [8], the wealth was multiplied by the return rate plus 1 in EQ#1 of that reference, so the wealth was being measured on a linear scale). Most notably, [8] subtracted the scaled variance from the linear assets, rather than subtracting it from the logarithmic assets, making Expressions 10 and 3 very different from one another.

Differentiating Expression 10 with respect to 1, and assuming lu(l)=lu, and lσ(l)=lσ, (i.e., if l is in the region where the leveraged growth rate grows linearly with leverage), and solving for 1, leads to the optimal leverage where the criterion is maximized:

$$optimal leverage , {l}_{opt} = \frac{u}{b {σ}^{2}} . \qquad ( 11 )$$

To fully specify the utility function and optimal leverage, it seems most reasonable to set b=1 in the three previous expressions, making the objective to minimize the expected multiplicative inverse of the assets. (It should be noted that, despite the similarity between Expression 11 using b=1, and Expression 2, the parameters used presumably have quite different definitions.) The primary motivation for this choice of b is that, intuitively, the risk of bankruptcy seems inversely proportional to the amount of assets, and thus this objective would effectively seek to directly minimize the risk of bankruptcy. The term “bankruptcy”, simplified here from its normal definition, is used in the sense that A₀, the total portion of gross assets considered eligible for investment (also used as the denominator component of the leverage) reaches zero.

This utility function differs from the linear and logarithmic utility functions in that the perceived value improves more slowly when the assets are large, as can be seen by observing that the derivatives of the linear, logarithmic, and multiplicative inverse utility functions are proportional to 1, 1/y, and 1/y², respectively. With the expected multiplicative inverse utility function, it takes a 50% chance of a 100% gain to offset a 50% chance of a 33% loss, because ½*½+½*1/(⅔)=1, yielding no change in the expected reciprocal assets.

3.1.4 Acceptance of Itô's Lemma, and the Validity of the Expected Inverse Asset Objective Function

Observe that if the leverage is held constant at 1 (the number one), the above Taylor series analysis from Expression 4 ignored the presence of a distribution around μ. Due to Itô's Lemma, the expected rate of leveraged change of 1 n(A₀) per unit time is:

lμ−l²σ²/2. (12)

To attempt to re-derive this consequence of Itô's Lemma, using a computer algebra system (CAS), expanding 1 n (1+a+x) in a Taylor series around x=0, (for small x), one arrives at:

$$ln ( 1 + a + x ) \approx ln ( 1 + a ) + \frac{x}{a + 1} - \frac{{x}^{2}}{2 {a}^{2} + 4 a + 2} + \frac{{x}^{3}}{3 {a}^{3} + 9 {a}^{2} + 9 a + 3} - \frac{{x}^{4}}{4 {a}^{4} + 16 {a}^{3} + 24 {a}^{2} + 16 a + 4} . \qquad ( 13 )$$

Substituting a=l μ Δt and x=lσε\sqrt{Δt}, where ε is a Gaussian distributed random variable with mean 0 and unit variance that is known to grow in proportion to Δt, one can basically re-derive the consequence of Itô's Lemma from Expression 12 above, because it is transforming the stochastic differential equation for the fractional linear returns

$$\frac{d S}{S} = l μ d t + l σɛ + \sqrt{d t} ,$$

where S is the portfolio value, into a stochastic differential equation for the logarithm of

$$1 + \frac{d S}{S} ,$$

or the logarithm of one plus the fractional linear return in time dt.

After the above substitution for a and x, and taking the expected value, the first thing to notice is that the odd-powered terms in x will disappear, because the expected value of odd powers of a zero-mean Gaussian distributed variable are all zero. Now, in the limit that Δt→dt, for positive reals r>1, Δt^{r}→0, and the denominators would be dominated by the constant term, making the denominators independent of a, yielding:

$$〈 ln ( 1 + l μ d t + l σ ɛ \sqrt{d t} ) 〉 = ln ( 1 + l μ d t ) - \frac{{l}^{2} {σ}^{2} d t}{2} . \qquad ( 14 )$$

Expanding the 1 n(1+lμ dt) term to the first term in dt, we arrive at the above consequence of Itô's Lemma from Expression 12,

$$〈 ln ( 1 + l μ d t + l σ ɛ \sqrt{d t} ) 〉 = l μ d t - \frac{{l}^{2} {σ}^{2} d t}{2} . \qquad ( 15 )$$

The standard deviation of the (approximately) Gaussian distributed logarithm may be simply read off from the factors multiplying ε in the

$$\frac{x}{a + 1} = l σ \sqrt{d t}$$

term from Expression 13. This makes the above consequence of Itô's Lemma from Expression 12 simply a special case of the more general probability distribution transform y=1 n(1+x), using variables with different meanings from those above.

This special case simply serves as a non-traditional analysis of a probability density transformation when a random variable with an infinite tail distribution is analyzed in a transformation that for traditional analysis would require a finite-length tail, here due to the fact the logarithms log (x) are real-valued only for arguments x≧0. Here we have the transformation y=1 n(1+x), where x is allowed to have an infinite tail distribution, but only because x contains an infinitesimal factor.

Having once suggested that the expected inverse assets are a good measure of value, one should attempt to apply the expected inverse asset measure to the leveraged Gaussian distribution implied by Itô's Lemma.

Using the stochastic calculus logic from above, the probability density change of variable in Expression 16

$$y = l ( x - ln ( {A}_{0} ) + \frac{{σ}^{2}}{2} ) - \frac{{l}^{2} {σ}^{2}}{2} + ln ( {A}_{0} ) , \qquad ( 16 )$$

with an extra factor determined by the differential

dy=l dx, (17)

may be used to transform the unleveraged log-return distribution p_{Gauss} (x; 1 n(A)+Tμ−Tσ²/2, Tσ²) into the leveraged log-return distribution p_{Gauss} (y; 1 n(A)+lTμ−l²Tσ²/2, l²Tσ²).

Computation of the expected inverse assets using the leveraged Gaussian log-return distribution is accomplished using the integral:

∫_{-∞}^{∞}e^{-y}p_{Gauss} (y; 1 n(A₀)+lTμ−l²Tσ²/2, l²Tσ²) dy (18)

yielding the simpler result

exp(−[1 n(A₀)+T(lμ−l²σ²)]). (19)

Now minimization of the expected inverse assets implies maximization of

1 n(A₀)+T(lμ−l²σ²). (20)

There is again a marked similarity between this Expression and the above Expression 3 by Scott, et al. The major difference, however, is the highly variable subjective and unjustified τ parameter within Expression 3. Upon calculus-based analytic minimization with respect to the leverage l in Expression 20, we arrive at the optimal leverage for minimization of expected inverse assets,

$${l}_{opt} = \frac{μ}{2 {σ}^{2}} . \qquad ( 21 )$$

Notice that this is the “Half-Kelly” Criterion, mentioned above in the background section. Now instead of being an arbitrary fraction of the Kelly Criterion, use of this criterion is well-justified by a fundamental theoretical result.

By comparison, the expected linear assets integrate to A₀e^{lμT}, implying infinite leverage and ruling it out as a valid objective function; the expected log assets yield the continuous-time Kelly Criterion from Expression 2, with σ′=σ, as anticipated.

Seeing that the expected inverse assets appears to be a valid objective function as far as the Gaussian distribution of log-returns is concerned, it now makes sense to test out the objective function with simple 2-sided bets.

For one trial in a simple 2-sided bet, with inverse assets, the expected utility, with probability of winning as p and betting fraction l, is

$$\frac{p}{1 + l} + \frac{1 - p}{1 - l} \qquad ( 22 )$$

Setting the differential with respect to l to zero and solving for l yields the allowable solution for minimization of expected inverse assets:

$${l}_{opt} = \frac{1 - 2 \sqrt{p - {p}^{2}}}{2 p - 1} . \qquad ( 23 )$$

For two trials of a two-sided bet, the inverse asset objective multiplies the binomial probabilities by the inverse asset outcomes of each possibility.

$$\frac{{p}^{2}}{{( 1 + l )}^{2}} + \frac{{( 1 - p )}^{2}}{{( 1 - l )}^{2}} + 2 \frac{p ( 1 - p )}{( 1 + l ) ( 1 - l )} \qquad ( 24 )$$

Setting the differential with respect to l to zero and solving for l yields the same allowable solution as in Expression 23. In fact, carrying out this analysis on cases 1 trial through 4 trials all yield the same optimal leverage formula for simple 2-sided bets, Expression 23, leading to the conjecture that it is valid as an optimum for any number of bets to be placed.

More generally, for leveraged winning payoff la and leveraged losing cost lc, the optimal leverage analogous to Expression 23 becomes (again conjectured to hold for any number of Bernoulli trials):

$${l}_{opt} = \frac{ac - ( c + a ) \sqrt{ac ( p - {p}^{2} )}}{p ( {ac}^{2} + {a}^{2} c ) - {a}^{2} c} . \qquad ( 25 )$$

To get the idea of how the discrete time leverage criterion in Expression 23 compares to the Kelly Criterion, consider the case when p=0.55. Expression 23 yields a betting fraction of approximately 5.01%, whereas the Kelly Criterion says to bet exactly 10%. Both criteria gradually increase the fraction to 100% as p approaches 1. For the most practically relevant values of p near 0.5, the Kelly Criterion says to bet about twice as much as the inverse asset objective, indeed making the two criteria very different from one another.

Seeing that the inverse asset objective yields valid optima for these simple typical forecasts of returns, there is now the problem and question of whether it is better to maximize the expected logarithmic utility function, or minimize the expected inverse asset objective function.

3.2 Solution to Problem: Narrowing Possible Objective Functions to only the Minimization of Expected Inverse Assets

Given these two objective functions with valid optima, they should be somehow compared, to determine whether there is a single prominent measure of value. This can be done using a simple cross evaluation method.

Start by measuring the maximal expected logarithm utility function's optimal leverage using the expected inverse asset objective function, as follows. Plugging the Kelly Criterion leverage from Expression 2, with σ′=σ, into the Expression 20 to be maximized for minimal expected inverse assets simply yields 1 n(A₀), or zero expected improvement over time.

For the other half of the cross evaluation, the minimal expected inverse assets objective function's optimal leverage is measured using the expected logarithm of assets utility function. Plugging the optimal expected inverse assets' leverage from Expression 21 into the expected rate of leveraged change of 1 n(A₀) due to Itô's Lemma, lμ−l²σ²/2, yields

$$\frac{3 {μ}^{2}}{8 {σ}^{2}} ,$$

a significant improvement over time.

Though the above analysis applies only to a Gaussian forecast distribution of log-returns, the same method can be applied to the discrete Bernoulli distribution of returns, showing similar results. First, plug the optimal Kelly leverage 2(p 0.5) into the corresponding inverse asset objective, Expression 22. This simply yields

$$\frac{p}{1 + 2 * ( p - .5 )} + \frac{1 - p}{1 - 2 * ( p - .5 )} = \frac{p}{2 p} + \frac{1 - p}{2 - 2 p} = 1 ,$$

or no improvement in the expected inverse assets over time, for any value of p.

Conversely, plugging the expected-inverse-asset-optimal leverage from Expression 23 into the following expected log-asset utility function

plog(1+l)+(1−p)log(1−l) (26)

produces a function (shown as the y-axis label in Drawing 1) that when plotted for winning probability values p on the open domain (0.5, 1), as shown in Drawing 1, shows a steadily rising function starting near and above zero, implying that for values of p with winning probability greater than 0.5, there is improvement, over time, in the log-assets.

The above fair comparison using a simple cross evaluation method shows that the expected inverse assets measure is probably a better measure of value or risk, for use in investment decision making, than the expected log assets measure.

### 3.2.1 Optimal Leveraging Should be Determined by the Short Term Return Distribution

Over the long term, log-return distributions are known to become Gaussian, due to the continual time convolution of the instantaneous distribution of log-returns. It is then tempting to apply the newly-derived long term Gaussian optimal leveraging from Expression 21. However, the anticipated Gaussian distributed log return may not be what is actually realized if that strategy is followed, because every price fluctuation results in a potential purchase or sale to maintain constant leverage (if the leverage is anything but 1), resulting in additional gains and losses that might disrupt the overall Gaussian distributed log returns.

The above thinking inspires the notion that it is the instantaneous price distribution, specifically not the long term distribution, that should determine optimal leveraging, where the time frame of the instantaneous distribution is defined as one in which the investment(s) may be releveraged, given liquidity constraints. Any known autocorrelation or negative autocorrelation in an investment, where any price movement displaced from the average tends to indicate the direction and displacement from average of the following price movement, should trigger releveraging trades, so that there should be little or no detectable autocorrelation in the equity curve of the investor. If method A is always expected to improve the expected inverse assets better than any other method from one moment to the next (given the instantaneous forecast), method B could never recover the lost ground, since the displacement from the average movement in the next movement of the equity curve is theoretically independent of the displacement from average of the prior movement in the equity curve.

Although in theory stochastic differential equations tend to deal with instantaneous Gaussian distributions, other models may be more appropriate in practice. For example, an instantaneous histogram model of log-returns might be judged as more appropriate, and more applicable for common practice. An interesting effect of this seems to be that the leveraging in a retirement portfolio should be directed by the instantaneous distribution, the same as any other portfolio.

3.2.2 Forming a Histogram Distribution from a Historical Time Series

It seems most computationally practical to process general probability distributions as histograms with many intervals. First, to produce a histogram of forecast “instantaneous” (as defined earlier) log-returns, for example, a time series of historical log-returns (that somehow also correctly takes account of dividends, capital gains distributions, splits, and reverse splits) could be processed by giving weight to each sample, sorting the returns by the size of the log-return (computed for example over daily time frames, as log [price(dayᵢ)/price(dayᵢ₋₁)], where dayᵢ is more recent than dayᵢ₋₁), and partitioning the domain of log-returns into intervals by placing partition points between the sorted, weighted samples, giving interval space proportional to the amount of weight of the sample. For example, if two neighboring samples are of equal weight, the partition point would be placed halfway between the two samples. If the left sample has double the weight of the right sample, then the partition point would be placed two-thirds of the way to the right sample, making the left sample's portion of the interval twice as large as the right sample's portion of the interval between the two samples. The left and right ending intervals may be dealt with as the implementor sees fit. Each partition in the domain is then given the weight of its sample, to produce a histogram representing the probability distribution of log-returns. The weights given to samples may be exponentially fading according to the expression e^{80 t}, with the smaller weights given to older samples. The λ parameter could be optimized to maximize the entropy of the histogram, with the histograms temporarily normalized to unit variance for fairness of the entropy computation. Further fairly obvious processing would be required to transform that histogram into a histogram having equal-sized intervals, which would be convenient to have before further processing the histogram, e.g. for convolutions.

The log-return domain is of interest because it should produce more naturally precise forecast histograms for individual investments, while the linear return domain is of interest for other operations such as releveraging and convolutions. The transform of a histogram from the log-return domain to the fractional linear-return domain is a nonlinear transform akin to a change of variable in an integrand, to more easily analyze an integral problem from calculus. The transform is accomplished with simple application of the transform y=e^{x}−1 to the borders x of the domain intervals, and the probability of each interval remains the same as before. The height of each domain interval is adjusted to make the width times the height of the interval equal to the probability of the interval. The reverse transform is accomplished with y=log(1+x) applied to the borders x of the domain intervals, followed again by the height adjustment.

### 3.2.3 The Distribution of Returns of a Combination of Leveraged Investments, and Optimization Thereof

This section discusses methods for computing the forecast distribution of returns of a combination of investments, by first introducing a moment-correcting convolution method, and instead later settling on a method that more directly computes the combined return histogram.

To express the distribution of returns of a releveraged investment, the histogram must first be in the linear return domain, and then the borders are simply multiplied by the factor representing the change of leverage, i.e. l_{new}/l_{old}, while the heights are adjusted as above.

Because growth rates add in linear space rather than log-space, a simple convolution of the log-return distributions does not suffice. For example, if the log return distributions being combined actually are Gaussian, with lognormal distributions of linear returns, the combined distribution of returns is a convolution of lognormal distributions, for which it is well known that there is no simple exact mathematical expression (without using integrals) to compute even the resulting mean or standard deviation.

The convolved linear return distribution p_{y}(y) of a combination of linear return random variables x₁, . . . , xₙ, is expressed as

p_{y}(y)=pₓ_{₁}(x₁)*pₓ_{₂}(x₂)* . . . *pₓ_{ₙ}(xₙ), (27)

where the asterisk is used to denote the convolution operation, defined as p_{z}(z)=pₓ(x)*p_{y}(y)=∫ pₓ(z−y) p_{y}(y) dy=∫ pₓ(x) p_{y}(z−x) dx (with two forms to illustrate commutativity). In practice, the linear return distributions could be expressed as histograms, and the discrete summation form of the integrals could be used to compute convolutions.

To compute the linear return distribution of a combination of leveraged investments, first the unleveraged linear-return distributions of the individual investments are leverage-transformed as above. Then leveraged linear-return distributions are convolved together into a single linear return distribution. Once the convolution of linear returns is computed, the convolved distribution could be translated up according to the net in-flow percentage of new money I added, as well as translated down by the cost of interest paid on margin debt, computed as max (0, −M+Σᵢ₌₁ⁿ|lᵢ|0(e^{r}−1), with exponential growth rate per time period r of the margin account debt, and maximum leverage M (normally 1) beyond which margin interest is charged. These simple translations are shown in the following expression.

$$( convolved linear return distribution ) + I - max ( 0 , - M + {\sum }_{i = 1}^{n} \vert {l}_{i} \vert ) ( {e}^{r} - 1 ) \qquad ( 28 )$$

Also, Σᵢ₌₁ⁿ|lᵢ| should basically be less than the margin account's allowed maximum leverage, though most margin accounts set different equity requirements for different assets held on margin. Such complexities are slightly outside the scope of this publication, and are expected to be adequately solvable by a programmer in this subject domain.

Convolutions computed as in Expression 27 above compute the distribution of combined returns assuming that the distributions being combined are independent. It is relatively easy to do some postprocessing of the convolution of multiple distributions in the case where the individual distributions are correlated with each other. Though it is true that the variance of a sum of independent random variables is the sum of the variances of the individual variables, this fact does not hold in the case where the variables being summed are correlated and are therefore not independent. In the event where a set of random variables are summed (or convolved, if dealing with the distribution of the sum) with scaling factors defined by the elements of the leverage vector 1, the variance of the resulting sum is l^{T}Σl, where Σ is the covariance matrix of the unscaled variables. Thus, the variance of the convolution of a set of scaled correlated variables should be simply corrected to agree with the above fact, via multiplication of the factor \sqrt{l^{T}Σl/ν_{convolution}}, where ν_{convolution} is the variance of the convolution computed while assuming independence of the variables.

Put into practice with separate individual stocks, it appears that even the variance correction of the resulting convolution from Expression 27 is not enough to describe the convolution distribution to provide accurate optimal leverages; in fact, even higher order terms of interdependence are at play in a highly correlated stock market where stocks all tend to move together. However, it doesn't seem very simple to directly perform these higher order corrections of 3rd and 4th moments, because while there are only

$$( \begin{matrix}d \\ 2\end{matrix} ) = \frac{d !}{( d - 2 ) ! 2 !} = d ( d - 1 ) / 2$$

variance and covariance coefficients (with d being the number of stocks), there are already

$$( \begin{matrix}d \\ 3\end{matrix} ) = \frac{d !}{( d - 3 ) ! 3 !} = d ( d - 1 ) ( d - 2 ) / 6$$

third moment coefficients contained within a symmetric 3 dimensional tensor matrix. Note that each of these centralized moment coefficients is computed as [symbol] (xᵢ− x̅ᵢ)(xⱼ− x̅ⱼ)(xₖ− x̅ₖ) [symbol] , where x̅ᵢ represents the mean of the i^{th} variable (out of d variables). To compute the expected 3rd moment of the convolution given the leverage vector of weights of each stock, the “cubic form” of the 3d tensor matrix is computed using this leverage vector: first the cubic matrix is multiplied by the leverage vector to yield a symmetric 2d matrix formed from that linear combination of (symmetric) 2d stacked matrices of the 3d cubic tensor matrix. Finally the expected 3rd moment of the convolution is reached as the quadratic form l^{T}Σl of this symmetric 2d matrix Σ with respect to the leverage vector l. Once the expected moments are known, given, e.g., the first 3 expected moments of the convolution, the points of the convolution distribution itself can be transformed using a polynomial with 3 coefficients, because it is possible to use the 3 moments to find 3 polynomial coefficients that will make the distribution match those moments, via the solution of a system of nonlinear equations.

Fortunately there is an easier and better way that avoids computing convolutions, tensor matrices, and solving systems of nonlinear equations, while producing an even more accurate representation of the distribution of the combination of returns. This method directly computes the samples of the combined distribution by taking the dot product of the d-dimensional leverage vector with each time series sample vector of d linear returns (computed for example over daily time frames, as price(dayᵢ)/price(dayᵢ₋₁)−1) of the investments as they co-occur. Perhaps, before taking the dot product, the carefully evaluated log-return forecasts of the individual investments could be taken into account to translate all the log-returns (calculated as log(1+linear_return)) of an investment up or down to have the correct forecast mean log-return. Once the translation is performed, the log returns are exponentiated and have 1 subtracted to yield the aforementioned linear returns which are multiplied in a dot product with the leverage vector. The resulting combined time series is then simply made into a histogram of log-returns by taking the logarithm of the samples with 1 added and then following the procedure given in Section 3.2.2 above for forming a histogram from a time series. That log-return histogram should then be transformed to the histogram of linear returns, and the resulting histogram could be translated according to Expression 28 to take account of margin interest expense and cash inflows or outflows. This linear return histogram should be transformed yet again to the log domain and then transformed into a histogram with equal-sized intervals, in preparation for the computation of the expected value of the inverse assets.

Using this method to combine multiple leveraged investment distributions into a log-return distribution for the entire portfolio, a numerical optimization algorithm may be applied, perhaps with constraints on the leverages to express qualitative diversification goals or margin limits, to find the optimal leverage vector of leverages such that E[e^{-X}] is minimized, where X=log(1+Y), and Y is a random variable representing ( 1/100^{th} of) the percent gain. Thus, assuming without loss of generality that the initial assets are 1, E[e^{-X}]=E[1/(1+Y)] correctly computes the expected inverse of the assets, and the optimization algorithm attempts to find the best possible leverage vector for minimizing the expected inverse assets.

### 3.3 Advantageous Effects of the Invention

Intuitively the multiplicative inverse utility function seems to minimize risk of bankruptcy. Furthermore, the elimination of other utility functions from consideration should allow more consensus and confidence to form in the world of financial economics. A greater common understanding of safe levels of leverage could increase the usefulness of markets in society.

As Chan pointed out [4], for an investment that was chosen for its good Sharpe ratio, leverage can be further optimized, because the Sharpe ratio is basically unaffected by the leverage.

The expected inverse asset objective function is significantly safer than the Kelly Criterion, since it invests only about half of what the Kelly Criterion would say to invest, in a couple of fairly realistic analytic scenarios. Widespread knowledge and usage of the expected inverse asset utility function would probably make markets less susceptible to dangerous financial bubbles.

It may be reasonable to expect greater returns from a retirement fund portfolio, as there are no longer any subjective risk tolerance parameters to consider. Leverages should theoretically depend only on the instantaneous (subject to liquidity constraints) forecast of returns, rather than requiring sufficient time for an “aggressive” investment to be considered “safe.”

### DESCRIPTION OF EMBODIMENTS

### 4.1 Example: Leveraging in Market Equities Leveraging in market equities can be accomplished by simply reviewing Sections 3.2.2 and 3.2.3.

### 4.2 Example: Leveraging with Debt

The root objective of minimizing the expected reciprocal assets seems to imply that the assets must be positive in order for the objective to be applicable. However, because the reason for minimizing the reciprocal assets is to avoid bankruptcy, the assets available for investment, which could include available debt (but excluding margin account debt), are the true quantity whose expected reciprocal should be minimized Recall from the Background Section 2 that the assets available for investment (including debt assets but excluding margin debt) were also used as the denominator component in this document's definition of leverage.

If the non-margin debt taken has a repayment schedule, the repayment requirements usually increase with time, degrading the growth rate in the future. Thus to maintain a low risk of bankruptcy in the future, a forecast is required of the earnings distribution, and preferably their dependence on leverage, through time. Given this general forecast, the goal should be to apply a debt payoff and investment strategy (controlling the leverage through time) that aims for a steady exponential growth rate in the assets (which are considered eligible for investment) while basically minimizing the maximum, over time, of the expected value of the inverse assets.

The optimal amount of debt to carry has also been determined, because both the debt payoff schedule and the possibility of taking additional debt are considered in the optimization process.

### 4.3 Example: Leveraging in Insurance

An insurance company would invest their assets just as any investor would, as far as balancing the leverages in their portfolio is concerned, with the very important exception that the percent cash inflows I in Expression 28 would not simply be a steady stream of income from insurance premiums, but rather fluctuate due to the payment of insurance claims. Periods of high insurance claim activity might tend to occur at the same time as a drop in market equity prices, making it more difficult to rely on selling investments to pay out on an abnormally large number claims. Thus it would be important to make forecasts of the joint probabilities of different investment returns and insurance claims, and optimize the insurance leverage parameters simultaneously with the investment leverage parameters, and thus in effect accounting for insurance revenue and claims the same way that investments are forecast, rather than considering the claims payments as regular cash outflows I in Expression 28.

The joint probabilities can be taken into account using either corrections to convolution forecasts to take account of co-occurrences due to 2nd order and other higher order moments, or perhaps it would be sufficient to simply take account of co-occurrences without the use of convolutions and instead by conjoining historical datasets using the time of occurrence of all events impacting assets levels from various classes of insurance and investment. It may be that different types of events have different liquidity constraints, and therefore occur over different time frames. To account for this complication, a minimum time frame could be set, perhaps at one-half of a day, and the cost or credit of the event could simply be spread evenly over the appropriate number of half-days, depending on the liquidity constraints of the event. The elements of each time series would simply be the linear asset levels at each time step if all assets (perhaps normalized to be initially 1) were invested in the investment or insurance class of that time series. Next, some carefully constructed investment or insurance class-specific forecast could be applied to each class of investment or insurance time series by, for example, adjusting the mean and perhaps variance of the class-specific time series to match the forecast. Finally a leverage vector that assigns a multiplier to each of the linearly-accounted investment and insurance time series is optimized by constructing a combined time series using the leverage vector and then constructing a histogram (as described in Section 3.2.2) from the combined time series, from which the expected inverse assets are computed, in effect from each leverage vector. The optimization algorithm would then proceed to spend some amount of time attempting to find a leverage vector that makes the expected inverse assets as small as possible. The resulting optimized leverage vector is then interpreted as the optimal amount to invest in each investment class or equity, and the optimal number of units of each insurance class to insure.

### 4.4 Example: Leveraging in a Retirement Portfolio

Leveraging in a retirement portfolio should be covered by the same framework as leveraging in equities, e.g. following the framework set out in Sections 3.2.2 and 3.2.3. Particularly in a retirement portfolio, the net regular inflow I from Expression 28 would typically be negative, and basically as large as the retiree's regular cash requirement from the portfolio. As will be shown, because I is negative in a retirement portfolio, rather than positive, the total leverage will be smaller as compared to an equivalent portfolio with positive I, due to the entire histogram of returns being shifted down rather than up, thereby emphasizing the negative returns in the histogram.

The example at the end of Section 3.1.3 illustrates a biased aversion of the expected inverse asset utility function against downside returns. Intuitively (after using numeric simulations), it just seems that after shifting all the returns in a return distribution histogram down by a constant, the total leverage must be shrunken to maintain optimality. Intuition can be misleading though, so the mathematical proof of this can be seen by consideration of a few expressions.

If the expected inverse assets are computed using the sum Σᵢ₌₁ⁿwᵢ/(1+lrᵢ), where leverage is l, and the rᵢ are the linear percent gains in a histogram weighted by wᵢ, the situation where the histogram is shifted down by a constant c is represented by the following expression for expected inverse assets: Σᵢ₌₁ⁿwᵢ/(1+lrᵢ−c). If the leverage is optimized for the first unshifted scenario, then the derivative of that expression with respect to l is equal to zero: Σᵢ₌₁ⁿ−wᵢrᵢ/(1+lrᵢ)²=0. But notice that breaking it up into separate sums for positive and negative rᵢ, such that the sum of the derivative terms over the set Sₙ={i|rᵢ<0} of indices corresponding to negative rᵢ, and the negated sum of the terms over the the set of indices Sₚ={i|rᵢ≧0} corresponding to positive rᵢ, equal each other: Σ_{i∈S}_{ₙ}−wᵢrᵢ/(1+lrᵢ)²=Σ_{i∈S}_{ₚ}wᵢrᵢ/(1+lrᵢ)².

Now, considering the scenario where each of the post-leveraged linear percent returns lrᵢ in the histogram are shifted down by a fixed amount c (with 0<c<1+lrᵢ, ∀i), the corresponding derivative terms equation becomes a strict inequality, by observing that

$${\sum }_{i ∈ {S}_{n}} \frac{- {w}_{i} {r}_{i}}{{( 1 + {lr}_{i} - c )}^{2}} = {\sum }_{i ∈ {S}_{n}} \frac{- {w}_{i} {r}_{i}}{{( 1 + {lr}_{i} )}^{2} {( 1 - \frac{c}{1 + l {r}_{i}} )}^{2}} > \frac{1}{{( 1 - c )}^{2}} {\sum }_{i ∈ {S}_{p}} \frac{{w}_{i} {r}_{i}}{{( 1 + {lr}_{i} )}^{2}} > {\sum }_{i ∈ {S}_{p}} \frac{{w}_{i} {r}_{i}}{{( 1 + {lr}_{i} )}^{2} {( 1 - \frac{c}{1 + {lr}_{i}} )}^{2}} = {\sum }_{i ∈ {S}_{p}} \frac{{w}_{i} {r}_{i}}{{( 1 + {lr}_{i} - c )}^{2}} . \qquad ( 29 )$$

This inequality shows that the derivative of the expected inverse assets with respect to l is positive after shifting the histogram down by c. Thus, by increasing the leverage, the utility function gets worse and so the leverage should, indeed, be decreased when the histogram is shifted down.

As mentioned at the end of the Advantageous Effects section (§3.3), it seems there are no longer any subjective risk tolerance parameters to take into account, and leveraging depends only on the instantaneous (subject to liquidity constraints) forecast of returns. Though leverage should be lower than it would be without the regular disbursements from the portfolio, it is still optimally guided by the expected inverse asset objective.

### INDUSTRIAL APPLICABILITY

Despite its simplicity, minimization of the expected multiplicative inverse assets is a non-obvious leveraging strategy, distinguished by straightforward analysis, and potentially applicable by any financial entity as their root leveraging optimization criterion. It would be particularly applicable for managing risk for insurance, portfolio balancing, total leverage analysis, and perhaps even credit rating.

Expected inverse asset optimized leveraging is a process that could be applied individually to millions of retirement accounts, to quantitatively optimize a qualitative strategy. General wasteful uncertainty about market risk levels could be greatly reduced by increased consensus brought about by the mathematical soundness of the expected inverse assets objective.

### REFERENCES

[1] D. Bernoulli, “Exposition of a new theory of the measurement of risk.” Econometrica, vol. 22, pp. 22-36, 1954, translated to English by Louise Sommer, originally published 1738.
[2] S. Russell and P. Norvig, Artificial Intelligence: A Modern Approach, 2nd ed. Prentice Hall, 2002, ch. 16.3.
[3] J. Kelly, Jr., “A new interpretation of information rate,” Bell System Technical Journal, vol. 35, pp. 917-926, 1956.

### [4] E. Chan, Quantitative Trading: How to Build Your Own Algorithmic Trading Business. Wiley, 2008.

[5] E. O. Thorp, “The Kelly criterion in blackjack sports betting, and the stock market,” in Proceedings of the 10th International Conference on Gambling and Risk Taking, Montreal, June 1997.

### [6] W. Poundstone, Fortune's Formula. Hill and Wang, 2005.

[7] O. Peters, “Optimal leveraging from non-ergodicity,” Quantitative Finance, vol. 11, pp. 1593-1602, 2011.
[8] J. Scott, C. Jones, J. Shearer, and J. Watson, “Enhancing utility and diversifying model risk in a portfolio optimization framework,” U.S. Pat. No. 6,292,787, Sep. 18, 2001.
[9] R. Mulvaney and D. S. Phatak, “Regularization and diversification against overfitting and over-specialization,” University of Maryland, Baltimore County, Computer Science and Electrical Engineering TR-CS-09-03, Apr. 3, 2009.
[10] R. Mulvaney, “Leveraging to minimize the expected multiplicative inverse assets,” U.S. Utility patent application Ser. No. 13/052,065, Mar. 19, 2011.
[11] ______, “Leveraging to minimize the expected inverse assets,” U.S. Utility patent application Ser. No. 14/021,195, Sep. 9, 2013.
[12] ______, “Leveraging to minimize the expected multiplicative inverse assets,” U.S. Provisional 61/320,483, Apr. 2, 2010.

1. An improved financial portfolio leverage planning process is claimed
wherein the process takes account of information to produce a leverage plan;
wherein a financial portfolio is defined as a list of investments along with a vector of leverages, called a leverage vector, to specify the amount of each investment;
wherein an investment is defined here as money placed under risk with the hopes of a positive return on the amount invested, and investments are distinguished from one another by one or more cohesive factors;
wherein the claimed process above is comprised of the following elements:
any method to produce a forecast of the instantaneous return distribution of an investment;
any process of computation of a single portfolio-wide instantaneous forecast linear return distribution, carried out by a programmable computation device, from forecasts of all the investment components of a leverage-vector-weighted portfolio, and possibly including any regular interest payments and inflow or outflow of cash;
and any numerical variable optimization algorithm, to determine, within a given, possibly iterated, time limit, an optimized portfolio leverage vector to invest by minimizing the expected inverse assets of the portfolio, given the portfolio-wide instantaneous forecast linear return distribution for any leverage vector and net inflow of cash after interest;
wherein the claimed improvement is:
minimization by the optimization algorithm of the newly derived expected-inverse-asset objective function, to achieve reduced risk in the form of having a low probability of having nearly zero assets available to invest, via optimized modification of the leverage vector of the portfolio.
